(19) United States
(12) Patent Application Publication
(10) Pub. No.: US 2011/0187861 A1
(43) Pub. Date: Aug. 4, 2011

(54) VEHICLE-MOUNTED SURVEILLANCE DEVICE

(75) Inventor: Tsutomu TOTANI, Aichi (JP)

(73) Assignee: Beat-Sonic Co., Ltd., Nisshin-shi (JP)

(21) Appl. No.: 12/835,192

(22) Filed: Jul. 13, 2010

(30) Foreign Application Priority Data
Feb. 1, 2010 (JP) 2010-019855

(51) Int. Cl. H04N 7/18; G01S 19/40

(52) U.S. Cl. 348/148; 342/357.23; 348/E07.085

(57) ABSTRACT

A vehicle-mounted surveillance device which includes at least one camera and a device body equipped with a clock, wherein an image taken by the camera is electrically converted into image data, time data is generated based on a time obtained by the clock, and the time data is embedded in the image data so that record data is generated and sequentially recorded on an external recording medium, the device further including a time correction unit which is located on the device body and includes a time signal receiving circuit which receives a radio wave embedded with time information, the time correction unit automatically correcting the time of the clock based on the periodically received time information.

### CROSS-REFERENCE TO RELATED APPLICATIONS

This application is based upon and claims the benefit of priority from the prior Japanese Patent Application No. 2010-19855, filed on Feb. 1, 2010, the entire contents of which are incorporated herein by reference.

### BACKGROUND

1. Technical Field

The present disclosure relates to a vehicle-mounted surveillance device which records driving information as a drive recorder during driving of a vehicle such as an automobile and further records status inside and outside the vehicle as a surveillance camera during parking of the vehicle.

2. Related Art

A drive recorder has conventionally been known as a device that records driving information about an automobile. The drive recorder comprises a camera for taking an image, which image is electrically converted into image data. The image data is temporarily recorded on a cache memory or the like. When an impact larger than a predetermined threshold is detected by an acceleration sensor, image data recorded immediately before and immediately after the impact is extracted from the temporarily recorded image data, being stored on an external storage medium such as a hard disk.

When the number of frames of the taken image per second is reduced, the image taken by the camera can be recorded as a still image that is advanced frame-by-frame. On the other hand, the taken image can be recorded as a moving image when the number of frames of the taken image is increased.

Japanese Patent Application Publication JP-A-2008-033846 discloses a driving information recording device which obtains location information and clock time information with respect to a vehicle from a GPS (Global Positioning System) device of car navigation system. The driving information recording device adds the obtained location information and clock time information to an image taken by a camera in conjunction with the GPS device, thereby generating image data.

Image data transmitted to the center to be stored is checked against the image data stored on the external storage device in order that whether falsification of image data has been carried out may be found. In the conventional drive recorders, however, the external storage device stores image data recorded for only several seconds immediately before and immediately after the impact on the vehicle body exceeds a threshold. Accordingly, there is a possibility that information necessary for resolution of more detailed cause of an accident, for example, how long a vehicle winded the road before occurrence of the accident, etc.

Furthermore, the conventional drive recorders store intermittent record for several seconds before and after an accident. Since clock time information added to the record is recorded by clocks incorporated in respective drive recorders, the occurrence time of an accident recorded differs on each drive recorder. As a result, the drive recorder is hard to accept as evidence.

In view of the aforementioned problem, the foregoing driving information recording device configured to be operated in conjunction with the car navigation system uses a time code superimposed on a GPS signal in order that several GPS or NAVSTER satellites may be synchronized with each other, with the result that the time recorded by the center is synchronized with the time of each driving information recording device. However, the clock time information of the GPS signal transmitted from a GPS satellite cannot sometimes be received. Furthermore, since the GPS signal is transmitted from a satellite located several thousand kilometers above, the clock time information reaches with delay, whereupon the clock time information is not an accurate standard time.

Furthermore, in order that the drive recorder may be operated in conjunction with a car navigation system, the drive recorder needs to be analyzed whether programs installed in the drive recorder and the car navigation system correspond to each other. This needs to be done for every one of car navigation systems of each manufacturer. Accordingly, analyzing compatibility of the drive recorder with the car navigation system is troublesome when a vehicle is furnished with a separate drive recorder.

### SUMMARY

Therefore, an object of the present disclosure is to provide a vehicle-mounted surveillance device which has a simpler arrangement and can easily mounted on the vehicle.

According to one aspect of the present disclosure, there is provided a vehicle-mounted surveillance device which includes at least one camera and a device body provided with a clock, wherein an image taken by the camera is electrically converted thereby to be formed into image data, and time data is generated based on a time obtained by the clock and then embedded in the image data so that record data is generated and sequentially recorded on an external recording medium, the device further comprising a time correction unit which is provided on the device body and includes a time receiving circuit which receives a radio wave embedded with time information, the time correction unit automatically correcting the time of the clock based on the periodically received time information.

### BRIEF DESCRIPTION OF THE DRAWINGS

In the accompanying drawings:

FIG. 1 is a schematic block diagram showing an electrical arrangement of the vehicle-mounted surveillance device according to one embodiment;

FIG. 2A is a schematic plan view in the case of use of four surveillance devices;

FIG. 2B is a schematic illustration showing an example of installation of the surveillance devices as viewed from outside the vehicle;

FIG. 2C is a schematic illustration showing the example of installation of the surveillance devices as viewed in the car interior;

FIG. 3 is a schematic illustration showing an example of installation of the surveillance device together with a convex mirror; and

FIG. 4 is a schematic block diagram showing a configuration of a folder formed in an external storage medium of the surveillance device.

### DETAILED DESCRIPTION

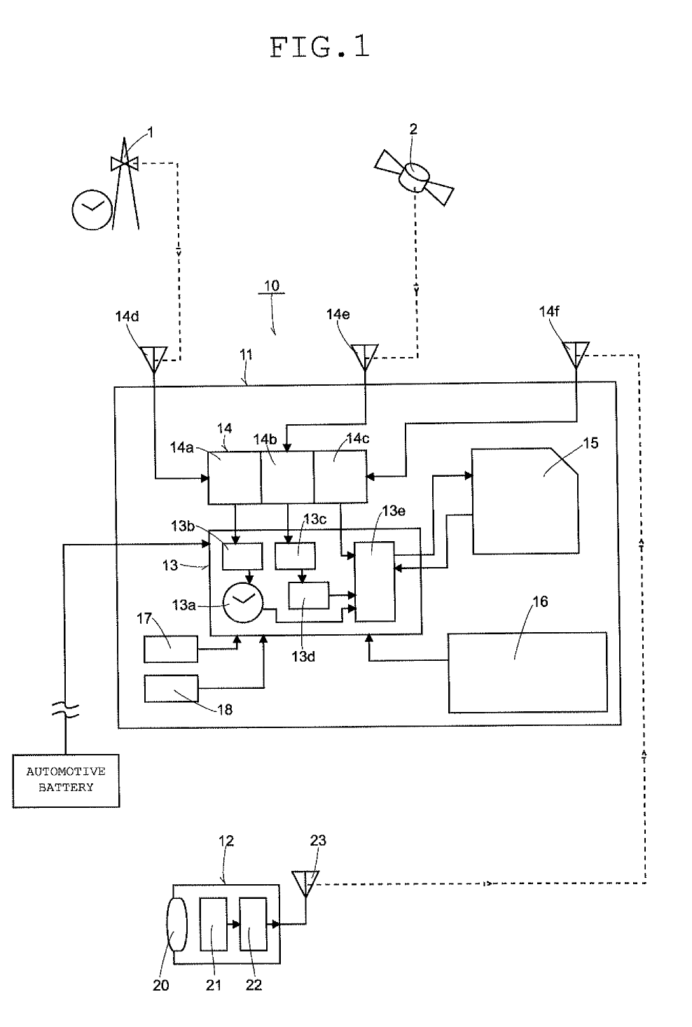

One embodiment will be described with reference to the accompanying drawings. Referring to FIG. 1, an electrical arrangement of the vehicle-mounted surveillance device 10 according to the embodiment is schematically shown. The surveillance device 10 is mounted on a car, for example and includes a device body 11 and a camera 12.

The device body 11 comprises a control circuit 13, a receiving circuit 14, an external recording medium 15, a battery 16, an impact sensor 17 and an input unit 18 provided with a switch. The camera 12 comprises a lens 20, an imaging device 21 further comprising a COD or CMOS, an encoder 22 and an antenna 23.

The control circuit 13 is provided with a clock 13a, a central processing unit (CPU) and a cache memory or the like temporarily storing data. An image taken by the camera 12 is converted to electrical image data. Time data comprising time information is then embedded in the image data, whereupon record data is formed.

Other data may also be embedded in the record data and include position information obtained from a GPS system, a magnitude of impact obtained from an impact sensor 17 and information about manual input operation. The record data is delivered to the external storage medium 15 in a time-series order according to the time data.

The control circuit 13 further includes a time correction unit 13b which corrects the clock 13a based on the standard time supplied from the receiving circuit 14 and a positioning unit 13c which forms latitude and longitude information based on a GPS radio wave supplied from the receiving circuit 14. The control circuit 13 still further includes a positioning correction unit 13d which corrects the latitude and longitude information and a record data control unit 13e which embeds time data and positioning data comprising corrected latitude and longitude information in the image data supplied from the receiving circuit 14, thereby delivering the formed record data to the external storage medium 15.

The receiving circuit 14 includes a time signal receiving circuit 14a, a position receiving circuit 14b and an image receiving circuit 14c all of which have respective antennas 14d, 14e and 14f.

The time signal receiving circuit 14a receives a long-wave standard time signal via the antenna 14d, thereby delivering a standard time signal to the control circuit 13. The long-wave standard time signal is the time delivered while being superposed on a long-wave standard radio wave. The long-wave standard radio wave is a radio wave transmitted at the frequency of 40 kHz or 60 kHz in Japan from the Standard Radio wave Transmitting Station 1. The long-wave standard radio wave is also used for an radio wave clock.

The time correction unit 13b of the control circuit 13 automatically corrects the time of the clock 13a in accordance with the standard time signal received periodically. Furthermore, when an engine of the vehicle starts and the surveillance device 10 starts, the time signal receiving circuit 14a also starting simultaneously receives a standard time signal. The time correction unit 13b automatically corrects the time of the clock 13a based on the received standard time signal. Consequently, the difference between the time of the clock 13a and the standard time can be rendered exceedingly small.

Furthermore, the time of the clock 13a is independently corrected without depending upon a clock incorporated in a vehicle-mounted electronic device such as a car-mounted computer or a car navigation system. Accordingly, even when the surveillance device 10 is mounted on a car separately from a car navigation system, the surveillance device 10 need not be synchronized with the car navigation system. As a result, the surveillance device 10 can easily be mounted on the car.

The time signal receiving circuit 14a receives the long-wave standard radio wave in the embodiment. Alternatively, the time signal receiving circuit 14a may receive a radio wave on which a standard time code is superposed.

For example, a GPS system measures a position by radio waves reaching from a plurality of satellites. In this GPS system, the GPS system time signal is superposed on a GPS radio wave in order that control operations of the plural satellites may be synchronized with each other. This GPS radio wave may be used as the time signal the receiving circuit 14a receives.

In FM multiplex broadcasting, system time data is superposed on a subcarrier band in which data signal is frequency-multiplexed. Accordingly, an FM broadcast wave may be used as the radio wave to be received by the time signal receiving circuit 14a. Since the aforesaid system time data is synchronized with the time of an FM broadcasting station which is adjusted to the Japan Standard Time, the difference between the time of the clock 13a and the standard time can be rendered exceedingly small.

Furthermore, the time receiving circuit 14a may receive a radio wave containing a time code from a time server which is used to synchronize systems of base stations of cell phones. Additionally, the surveillance device 10 may be provided with a circuit receiving a plurality of radio waves on which time codes are superposed respectively, as described above, so that the difference based on radio wave reaching distances of a base station from which a long-wave standard time signal is transmitted and the surveillance device 10.

The position receiving circuit 14b receives via the antenna 14e positioning radio wave transmitted from GPS satellites, delivering the received positioning radio wave to the control circuit 13. The positioning unit 13c of the control circuit 13 generates latitude and longitude information from the positioning radio wave, delivering the latitude and longitude information to the positioning correction unit 13d. The positioning correction unit 13d corrects the latitude and longitude information delivered thereto thereby to generate position data. The position data is delivered to the record data control unit 13e.

The image receiving circuit 14c receives by the antenna 14f image data delivered from the antenna 23 of the camera 12 to decode the image data. The decoded image data is delivered to the control circuit 13. The record data control unit 13e embeds the time data and the position data into the decoded image data, thereby generating record data. The position data may or may not be contained in the record data depending upon configuration of the surveillance device 10.

The external storage medium 15 has a main storage area on which the record data delivered from the control circuit 13 is sequentially recorded and a substorage area on which a copy of record data is recorded upon occurrence of traffic accident or manual operation. For the purpose of recording record data on the external storage medium 15, the record data control unit 13e of the control circuit 13 includes a record data classifying unit, a record data extracting unit and an automatic folder creating unit.

The record data classifying unit classifies record data in the order of time-series, based on time data contained in the record data to be recorded on the main storage area.

The record data extracting unit copies record data containing optional data such as impact data or manual operation data from record data to be input to the external storage medium 15 or record data recorded in the main storage area thereby to extract the record data.

The automatic folder creating unit includes an automatic main folder creating unit which automatically creates at least one main folder used to record the record data in the main storage area of the external recording medium 15 and an automatic subfolder creating unit which automatically creates at least one subfolder to record the record data containing optional data in the main storage area of the external recording medium 15.

Thus, the record data is recorded in the main folder in the order of time-series, and the record data containing the optional data generated in the case of detection of changes by a sensor or the like is copied to be recorded in the subfolder. As a result, the record data can be retrieved more easily.

The battery 16 is arranged so as to be instantaneously switched in response to instructions from the control circuit 13 in the case where the power supply from the vehicle body side is cut off, thereby supplying power to the device body 11. Since the automotive battery is used in conjunction with the secondary built-in battery 16, imaging is continued even when power supply from the vehicle body side is cut off upon occurrence of traffic accident or the like. Furthermore, imaging can be continued even during stopping of the vehicle since the vehicle-loaded battery with a large capacity is normally used as the power supply. Accordingly, the surveillance device 10 can be used as a security camera to monitor surroundings of the vehicle for a long period of time as well as the drive recorder.

The impact sensor 17 comprises an acceleration sensor which converts the movement of the device body 11 to acceleration thereby to detect the acceleration. When the detected acceleration exceeds a predetermined threshold, the impact sensor 17 delivers an impact data indicative of the magnitude of the detected acceleration to the control circuit 13. The impact data delivered to the control circuit 13 is embedded in the record data containing the time data and the position data by the record data control unit 13e. Since the record data to be recorded on the main folder of the main storage area is copied by the impact-data-embedded record data extraction unit of the record data extraction unit, the record data containing the impact data is formed into the record data recorded in the main folder of the main storage area and a copy of the record data. The copy of the record data is sequentially recorded in a first subfolder created in the substorage area by an automatic first subfolder creating unit of the record data control unit 13e. The first subfolder is named in the order of the time when the record data has been generated or copied. Accordingly, the record data embedded with the impact data can easily be retrieved.

Furthermore, since the record data embedded with the impact data contains the time data and the position data, the record data recorded before and after the record data embedded with the impact data recorded on the first subfolder can be cited from the main folder. As a result, the process leading to a traffic accident can be browsed for a long period of time and accordingly, the cause for the accident can easily be analyzed.

The input unit 18 includes a video-recording switch, for example and realizes imaging by a manual input operation. Since the input unit 18 also includes a manual input sensor, information about manual operation is delivered to the control circuit 13 when the input unit 18 has been manually operated. The control circuit 13 generates data of manual operation from the received manual operation information. The manual operation data is embedded in the record data containing the time data and the position data by the record control unit 13e. Since the record data to be recorded in the main folder of the main storage area is copied by a manual-operation-data-embedded record data extraction unit of the record data extraction unit 13e, the record data embedded with manual operation data is formed into the record data recorded in the main folder of the main storage area and a copy of the record data. The copy of the record data is sequentially recorded in a second subfolder created in the substorage area by a second automatic subfolder creating unit of the record data control unit 13e. The second subfolder is named in the order of the time when the record data embedded with manual operation data has been generated or copied. Accordingly, the record data embedded with the manual operation data can easily be retrieved.

An image taken through the lens 20 of the camera 12 is electrically converted to image data by the imaging device 21 and further coded by the encoder 22, being delivered from the antenna 23 toward the image receiving circuit 14c of the device body 11. The camera 12 is connected to the device body 11 by a wireless communication line and powered independently of the device body 11. Alternatively, the camera 12 may be powered directly from the automotive battery or via a USB connector provided as an input terminal in a car audio system. Furthermore, the camera 12 may be powered from the device body 11 when connected by wireline to the device body 11.

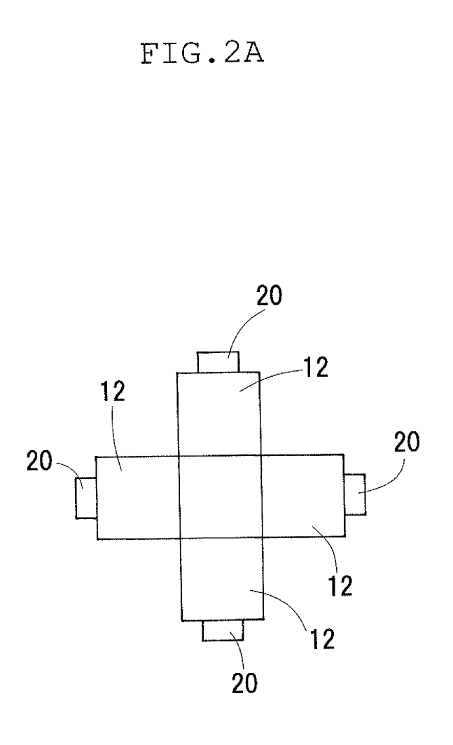

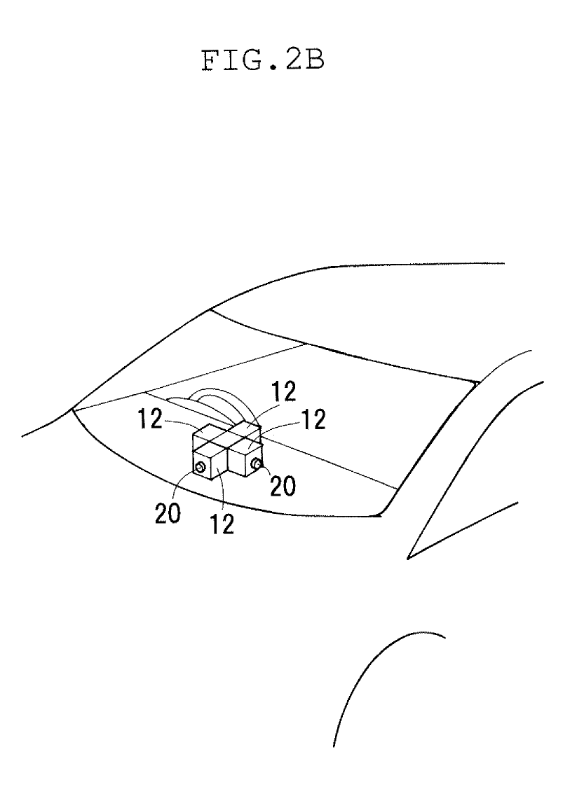

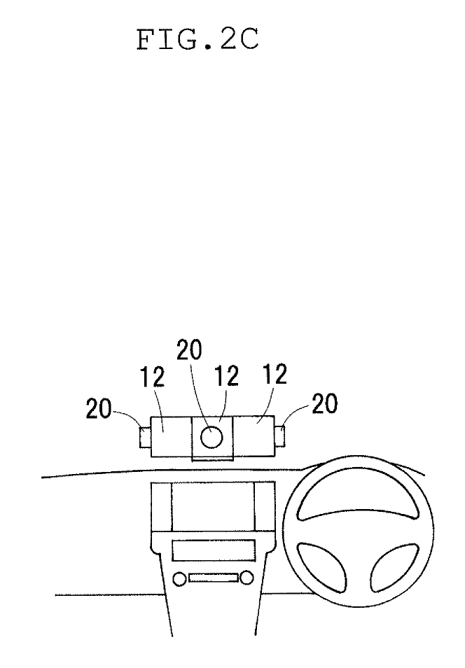

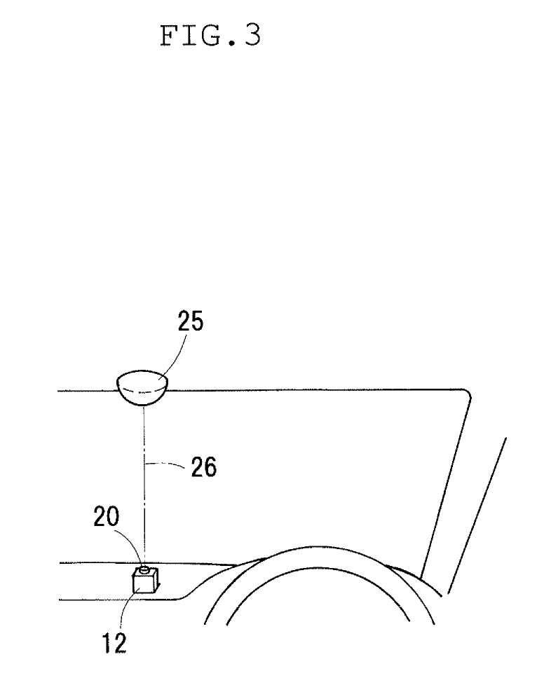

FIGS. 2A to 2C and 3 show examples of installation of the camera 12 on the vehicle respectively.

As a first example, four cameras 12 are installed so that the lenses 20 are directed in the front-rear directions and the right-left directions respectively as shown in FIG. 2A. Channels of the four cameras 12 are set so that interference is prevented. When the cameras 12 are installed on a dashboard as shown in FIGS. 2B and 2C, entire surroundings of the car including the outside and the inside of the car can be imaged.

As another example, as shown in FIG. 3, a convex mirror 25 with a spherical surface is mounted on the ceiling of the car body 11. A single camera 12 is placed opposite the convex mirror 25 so that optical axes of the convex mirror 25 and the lens 20 are located on substantially the same line as shown by an alternate long and short dash line 26 in FIG. 3. In this case, the entire surroundings of the car including the outside and the inside of the car can be covered by a field angle of the lens 12 and an image reflected on the convex mirror 25. Although the single camera 12 and the convex mirror 25 are used in the installation example in FIG. 3, a plurality of sets of the oppositely disposed camera 12 and convex mirror 25 may be installed in the car interior so that blind areas due to doors, seats and the like are eliminated.

The vehicle-loaded surveillance device 10 configured above will be used as follows. Upon completion of connection, the surveillance device 10 is powered from the automotive battery to be started. Upon start of the surveillance device 10, the time of the clock 13a of the control circuit 13 is corrected by the time correction unit 13b on the basis of the long-wave standard time signal received by the time signal receiving circuit 14a. Alternatively, the standard time signal may be received and the time of the clock 13a may be corrected when a switch (not shown) provided on the surveillance device 10 is turned on. Furthermore, the long-wave standard time signal is periodically received by the time signal receiving circuit 14a for the purpose of automatic time correction by the time correction unit 13b in addition to the aforementioned time correction at the time of start of the surveillance device 10. As a result, the difference between the time of the clock 13a and the standard time can be rendered exceedingly small.

Imaging by the camera 12 also starts concurrently with the above-described time correction. An image taken through the lens 20 is electrically converted to image data by the imaging device 21 and then coded by the encoder 22 to be delivered through a wireless communication line from the antenna 23 toward the image receiving circuit 14c.

In the control circuit 13 of the device body 11, time data is generated based on time information obtained from the clock 13a. The position receiving circuit 14b receives positioning wave transmitted from GPS satellites, delivering the received positioning wave to the control circuit 13. The positioning unit 13c of the control circuit 13 generates latitude and longitude information from the positioning wave, delivering the latitude and longitude information to the positioning correction unit 13d. The positioning correction unit 13d corrects the received latitude and longitude information, generating position data. The time data and the position data thus generated are embedded into the image data by the record data control unit 13e thereby to be formed into record data.

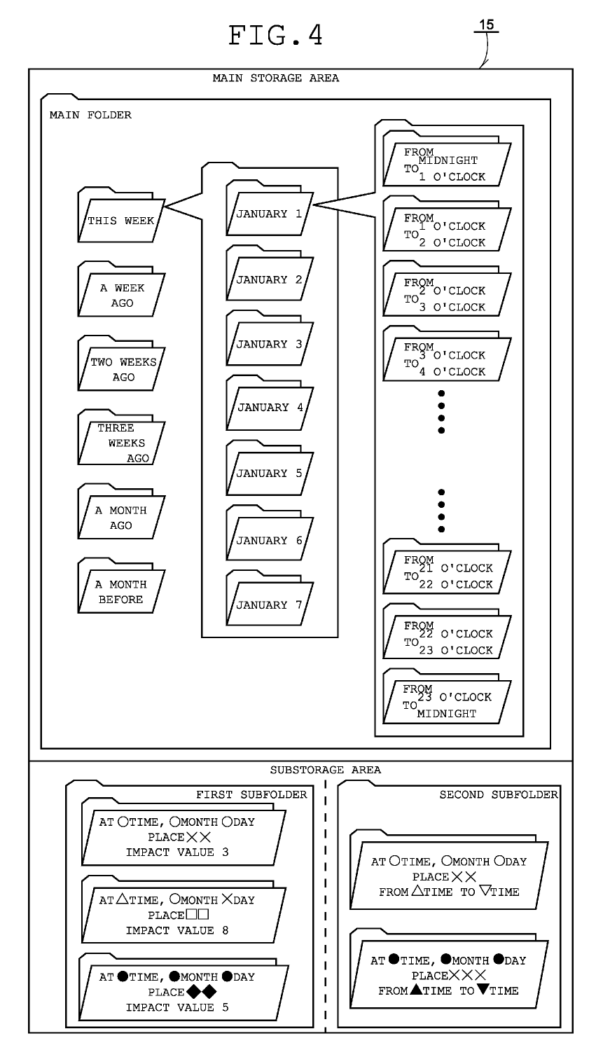

On the other hand, as shown in FIG. 4, the main folders are created in time series in the main storage area of the external record medium 15 by the automatic folder creating unit, and the first and second subfolders are created in the substorage area of the external record medium 15. A copy of record data containing impact data is stored in the first subfolder, and a copy of record data containing manual operation data is stored in the second subfolder.

The main folders created in time series are further created on monthly, weekly, day and hour bases into a hierarchy state. The record data is automatically classified by the record data classification unit based on the time data contained therein thereby to be stored into the time-series folder to which the record data belongs. Since the record data is automatically classified into the hierarchical main folders, the record data can easily be retrieved later. Furthermore, the record data stored in the respective main folders are organized in the order of time-series. The original record data is stored in the main folders whereas the copy of the original record data is stored in the subfolders. As a result, for example, record data generated for several minutes before the record data embedded with impact data can easily be taken out, whereupon analysis of accident cause can easily be carried out.

When the main storage area of the external record medium is completely filled with data, for example, an oldest one of the folders created on a monthly basis is overwritten. Thus, old record having less possibility of retrieval can automatically be organized. Furthermore, the record data stored in each main folder of the main storage area contains, as basic information, the time data and the position data. Accordingly, it can easily be confirmed when and/or where the record data was generated or when and/or where the image was taken. The time data and the position data are superimposed when the record data is reproduced. As a result, necessary information such as date and location of the imaging can be confirmed while the reproduced image is being browsed. Additionally, impact data or manual operation data both embedded in the record data may be displayed together with the reproduced image.

The device body 11 has the impact sensor 17. When the impact detected by the impact sensor 17 exceeds the predetermined threshold, impact data indicative of the magnitude of the impact is delivered to the control circuit 13 and then embedded in the record data by the record data control unit 13e, whereby the record data embedded with the impact data is generated. The generated record data embedded with the impact data is formed by the impact-data-embedded record data extraction unit into the original and a duplicate copy. The original data is stored in the main holder of the main storage area in the order of time-series by the record data classification unit of the record data control unit 13e. On the other hand, the duplicate copy is stored in one of the first subfolders formed in the substorage area. Thus, the record data can easily be retrieved later since data of time and location of impact due to sudden acceleration, crash stop or collision accident is stored in the first subfolder of the substorage area together with impact data.

The device body 11 is provided with the input unit 18 such as the recording switch. When the manual operation has been effected by the input unit 18, the manual input sensor of the input unit 18 delivers manual operation data to the control circuit 13. The manual operation data is embedded into the record data by the record data control unit 13e such that the record data containing the manual operation data is generated. The generated record data embedded with the manual operation data is formed into the original and a duplicate copy by the manual-operation-data-containing record data extraction unit. The original data is stored in the main holder of the main storage area in the order of time-series by the record data classification unit of the record data control unit 13e. On the other hand, the duplicate copy is stored in one of the second subfolders created in the substorage area. Thus, the record data embedded with the manual operation data is obtained when the manual operation is carried out for recording during automatic recording of the surveillance device 10. Since the record data embedded with the manual operation data is stored in the second subfolder, the record data can easily be retrieved later.

A power source equipped on the vehicle includes two systems, that is, a normal automotive battery and an alternator. The surveillance device 10 of the embodiment is arranged so as to be powered directly by the automotive battery. Accordingly, the surveillance device 10 can be operated even during non-operation of an automotive engine. For example, even in the occurrence of hit-and-run accident during parking, a counterpart vehicle can easily be specified by the surveillance device 10 which continues operation during the hit-and-run accident. Furthermore, for example, even when the surveillance device 10 is dismounted to be powered off as the result of unexpected occurrence such as traffic accident or motor-vehicle theft, the surveillance device 10 is instantaneously switched to the built-in battery 16. As a result, the surveillance device 10 can continue imaging while being powered by the battery 16.

According to the above-described surveillance device 10, the clock 13a is provided for generating time data to be embedded in the record data. The clock 13a is automatically corrected by the time correction unit 13b according to the long-wave standard time signal. Consequently, the difference between the time of the clock 13a and the standard time can be rendered exceedingly small. Thus, since the accurate time is recorded even in the occurrence of traffic accident or motor-vehicle theft, the surveillance device 10 can provide compelling evidence. Furthermore, since the position data is embedded in the record data as basic information, a location of the imaging at the time of the unexpected occurrence can be specified. Additionally, the surveillance device 10 can provide more detailed information during the imaging when the impact data detected by the impact sensor 17 and/or the manual operation data in the imaging by manual operation is embedded in the record data.

Although the surveillance device 10 is arranged to receive the long-wave Japan Standard Time signal in the foregoing embodiment, the embodiment should not be limited to the long-wave Japan Standard Time signal. The surveillance device 10 may be arranged to automatically receive standard time signals transmitted on radio waves defined by the respective states in the world so that the clock 13a is automatically corrected.

A vehicle with an internal combustion engine as drive source is now changing to a hybrid car equipped with a combination of the internal combustion engine and an electric motor and further to an electric car. A large number of cars will be loaded with respective large-capacity batteries.

On the other hand, a hard disk drive provided with a disk can easily achieve an increase in the capacity but has a characteristic of low capacity. Accordingly, the hard disk drive has a high possibility of breakage due to accident or the like. However, an external storage medium such as flash memory or solid state drive has no disk and accordingly a high shockproof. Accordingly, an external storage medium with a large memory capacity is now available. This recording medium is expected to have a larger memory capacity.

Since power consumption of the vehicle-loaded surveillance device 10 can be rendered smaller, the surveillance device 10 can be operated for a longer period of time even during parking when combined with a battery with a large capacity. Accordingly, for example, even when a hit-and-run accident occurs in a coin-operated parking lot at night, there is a higher possibility that images of cars including subject's car may have been taken by the surveillance device 10.

Furthermore, when a collision accident occurs at a street crossing, both parties sometimes give evidences conflicting with each other. In this case, however, analysis of the accident can easily be carried out when an image recorded by a third party is presented as evidence.

Still furthermore, the vehicle-loaded surveillance device 10 which is recordable for a long period of time can be used to supplement surveillance cameras which are now becoming widespread in shopping malls or shopping streets and residential streets.

Thus, when an area is monitored by a plurality of surveillance cameras which are synchronized with each other with respect to the information such as the time, location and the like, a process leading to an accident or crime can easily be analyzed as well as moment of accident or crime. Consequently, a technique for effectively preventing the accident or crime can readily be developed.

The foregoing description and drawings are merely illustrative and are not to be construed in a limiting sense. Various changes and modifications will become apparent to those of ordinary skill in the art. All such changes and modifications are seen to fall within the scope of the invention as defined by the appended claims.

1. A vehicle-mounted surveillance device which includes at least one camera and a device body provided with a clock, wherein an image taken by the camera is electrically converted thereby to be formed into image data, and time data is generated based on a time obtained by the clock and then embedded in the image data so that record data is generated and sequentially recorded on an external recording medium, the device further comprising:
a time correction unit which is provided on the device body and includes a time receiving circuit which receives a radio wave embedded with time information, the time correction unit automatically correcting the time of the clock based on the periodically received time information.

2. The device according to claim 1, wherein the radio wave containing the time information is a long-wave standard time signal.

3. The device according to claim 1, wherein when the device body is powered on, the radio wave embedded with time information is received by the time receiving circuit, and the time of the clock is automatically corrected by the time correction unit.

4. The device according to claim 1, wherein the device body includes a record data classification unit which classifies the record data, based on the time data embedded in the record data and an automatic folder forming unit which automatically forms at least one main folder in a main storage area formed in the external storage medium, the record data automatically classified by the record data classification unit based on the time data being stored in the main folder.

5. The device according to claim 1, wherein the device body includes:
a positioning unit which has a GPS receiving circuit which receives GPS waves transmitted from a plurality of GPS satellites respectively and forms latitude and longitude information based on the GPS waves received by the GPS receiving circuit; and
a positioning correction unit which corrects the latitude and longitude information formed by the positioning unit thereby to form position data which is embedded in the record data.

6. The device according to claim 1, wherein when the image taken by the camera is reproduced based on the record data, the time and/or the latitude and longitude information is superimposed on the reproduced image in accordance with the time data and/or position data both embedded in the record data.

7. The device according to claim 1, wherein the device body is mounted on a vehicle body and includes an impact detection unit which has an impact sensor detecting an impact applied to the vehicle body and forms impact data based on information about the impact when the detected impact has exceeded a predetermined threshold, and the formed impact data is embedded in the record data.

8. The device according to claim 7, wherein the device body includes:
a data extraction unit which duplicates the record data embedded with the impact data and extracts the duplicate of the record data embedded with the impact data; and
a first automatic subfolder forming unit which automatically forms at least one subfolder in a sub-storage area formed in the external storage medium, the record data extracted by the data extraction unit being stored in the subfolder.

9. The device according to claim 1, wherein the device body includes an input unit which is operated for manual operation of the camera and a manual operation detection unit having an input sensor which detects the manual operation by the input unit and forms manual operation data based on information about the detected manual operation, the manual operation data being embedded in the record data.

10. The device according to claim 9, wherein the device body includes:
a second data extraction unit which duplicates the record data containing the manual operation data and extracts the duplicate of the record data containing the manual operation data; and
a second automatic subfolder forming unit which automatically forms at least one subfolder in a substorage area formed in the external storage medium, the record data extracted by the data extraction unit being stored in the subfolder.

11. The device according to claim 1, wherein the device body is provided with a battery to which the device is switched immediately when power supplied from the vehicle body side has been cut off.

12. The device according to claim 1, wherein the camera and the device body are formed so as to be separate from each other and connected to each other by a wired or wireless electrical communication line.

13. The device according to claim 1, wherein latest record data is superimposed on oldest record data based on the time data of the record data when the external storage medium is full of data.

14. The device according to claim 1, wherein a plurality of the cameras is provided so as to image surroundings outside and inside the vehicle.

15. The device according to claim 1, which further comprises a convex mirror which is formed by cutting off a part of spherical surface, wherein the lens and the convex mirror are disposed oppositely so as to have respective optical axes substantially aligned with each other.

16. The device according to claim 2, wherein when the device body is powered on, the radio wave embedded with time information is received by the time receiving circuit, and the time of the clock is automatically corrected by the time correction unit.

17. The device according to claim 2, wherein the device body includes a record data classification unit which classifies the record data, based on the time data embedded in the record data and an automatic folder forming unit which automatically forms at least one main folder in a main storage area formed in the external storage medium, the record data automatically classified by the record data classification unit based on the time data being stored in the main folder.

18. The device according to claim 3, wherein the device body includes a record data classification unit which classifies the record data, based on the time data embedded in the record data and an automatic folder forming unit which automatically forms at least one main folder in a main storage area formed in the external storage medium, the record data automatically classified by the record data classification unit based on the time data being stored in the main folder.

19. The device according to claim 5, wherein when the image taken by the camera is reproduced based on the record data, the time and/or the latitude and longitude information is superimposed on the reproduced image in accordance with the time data and/or position data both embedded in the record data.
